(19) United States
(12) Patent Application Publication
(10) Pub. No.: US 2014/0293461 A1
(43) Pub. Date: Oct. 2, 2014

(54) DRIVE DEVICE, LENS BARREL AND IMAGING APPARATUS

(71) Applicant: SONY CORPORATION, Tokyo (JP)

(72) Inventors: HAJIME NAKAMURA, Tokyo (JP); TOMOYA TAKEI, Tokyo (JP); TOSHIAKI EDAMITSU, Tokyo (JP); YUTAKA MAEDA, Tokyo (JP); TSUTOMU NAITOU, Kanagawa (JP); TETSU TANAKA, Kanagawa (JP)

(73) Assignee: SONY CORPORATION, Tokyo (JP)

(21) Appl. No.: 14/215,268

(22) Filed: Mar. 17, 2014

(30) Foreign Application Priority Data
Mar. 26, 2013 (JP) 2013-064461

(51) Int. Cl. G02B 7/02

(52) U.S. Cl. CPC G02B 7/023
USPC 359/822

(57) ABSTRACT

A drive device includes a moving body having a driven portion with an engagement holding portion and an insertion portion, and an element holding portion holding an optical element; a piezoelectric driver having a piezoelectric element and a drive axis that moves the moving body while being inserted into the insertion portion; and a leaf spring being inserted into the insertion portion, being held by the moving body and urging the drive axis to the driven portion in a pressing direction. In a state in which the leaf spring is inserted into the insertion portion, the leaf spring is elastically deformed in the insertion portion by inserting the drive axis which is inserted into the insertion portion, and the drive axis is pressed against the driven portion by the leaf spring, while the leaf spring is engaged with the engagement holding portion and held by the moving body.

### CROSS REFERENCE TO RELATED APPLICATION(S)

This application claims the benefit of Japanese Priority Patent Application JP 2013-064461 filed Mar. 26, 2013, the entire contents of which are incorporated herein by reference.

### BACKGROUND

The present technology relates to a technical field regarding a drive device, a lens barrel and an imaging apparatus, in which the drive device adopts a piezoelectric driver having a piezoelectric element.

In imaging apparatuses such as a still camera and a video camera, there are provided various mechanisms such as a movement mechanism that moves optical elements such as a focus lens and a zoom lens in an optical axis direction, an image stabilization mechanism and an aperture mechanism. In order to take a desired photograph or video using such imaging apparatuses, it is necessary to drive the optical elements such as a lens and a blade. As an apparatus that drives the optical elements, a drive device adopting a piezoelectric element is in wide use.

Typically, a drive device adopting a piezoelectric element has a piezoelectric element and a drive axis. In such a drive device, when a voltage is applied to the piezoelectric element, the piezoelectric element expands and contracts, and the drive axis is displaced in an axial direction in response to the expansion-contraction thereof. The optical elements are driven by transferring the displacement of the drive axis to the optical elements. In this case, in order to efficiently drive the optical elements, it is necessary to press the drive axis against the optical elements or members that hold the optical element. As a method of pressing the drive axis against the optical elements or the members that hold the optical element, there is a known method using a leaf spring.

In the method of pressing the drive axis against the optical elements or the members that hold the optical element using a leaf spring, it is necessary to attach the leaf spring to the member that holds the optical element or to a casing of the imaging apparatus. As a method of attaching the leaf spring in the related art, for example, a method of attaching a leaf spring (contact press spring 14 in Japanese Unexamined Patent Application Publication No. 7-274544) to an optical element holding member (zoom lens barrel 11 in Japanese Unexamined Patent Application Publication No. 7-274544) using a screw, as illustrated in Japanese Unexamined Patent Application Publication No. 7-274544, or a method of attaching a leaf spring (clipping member 12 in Japanese Unexamined Patent Application Publication No. 2009-204928) to an optical element holding member (lens frame 11 in Japanese Unexamined Patent Application Publication No. 2009-204928) using a compression spring, as illustrated in Japanese Unexamined Patent Application Publication No. 2009-204928 is adopted.

### SUMMARY

Since the above-described methods in the related art use a screw and a compression spring, there is a desire for screwing or attaching the compression spring, thereby causing a disadvantage that it takes time to assemble a drive device.

Thus, it is desirable to improve efficiency in assembling the drive device utilizing the present technology.

According to an embodiment of the present technology, there is provided a drive device including a moving body that has a driven portion in which an engagement holding portion is provided and an insertion portion is formed being open at least on one side thereof and an element holding portion which holds an optical element; a piezoelectric driver that has a piezoelectric element and a drive axis, in which the piezoelectric element expands and contracts when a voltage is applied thereto, the drive axis is displaced in an expansion-contraction direction of the piezoelectric element in response to the expansion-contraction of the piezoelectric element and moves the moving body, and the drive axis is inserted into the insertion portion; and a leaf spring that is inserted into the insertion portion, is held by the moving body and urges the drive axis to the driven portion in a pressing direction. In a state in which the leaf spring is inserted into the insertion portion, the leaf spring is elastically deformed in the insertion portion by inserting the drive axis which is inserted into the insertion portion, and the drive axis is pressed against the driven portion by the leaf spring, while the leaf spring is engaged with the engagement holding portion and held by the moving body.

In this case, the leaf spring for urging the drive axis of the piezoelectric driver to the driven portion side is held by the moving body without adopting any specific holding member such as a screw or a compression spring, and thus, it is not necessary to attach a holding member such as a screw or a compression spring.

In the drive device according to the embodiment of the technology, it is preferable that a press-down portion be provided in the driven portion, and in a state in which the leaf spring is held by the moving body, dislodgement of the leaf spring with respect to the insertion portion be regulated by the press-down portion.

In this case, in a state in which the drive axis is inserted into the insertion portion, the dislodgement of the leaf spring with respect to the insertion portion is regulated.

In the drive device according to the embodiment of the technology, it is preferable that the leaf spring be formed in a manner where an insertion-extraction direction thereof with respect to the insertion portion is set as a short direction, and the engagement holding portions be provided being spaced apart from each other in a longitudinal direction of the leaf spring.

In this case, since the leaf spring is engaged with the engagement holding portions of the driven portion at two points which are spaced apart from each other in the longitudinal direction, distortion does not easily occur in the leaf spring.

In the drive device according to the embodiment of the technology, it is preferable that two of the engagement holding portions respectively engage with both end portions of the leaf spring in the longitudinal direction.

In this case, a force for deforming the leaf spring is small.

In the drive device according to the embodiment of the technology, it is preferable that two of the engagement holding portions engage with the leaf spring by being in line contact therewith.

In this case, the leaf spring does not easily clatter.

In the drive device according to the embodiment of the technology, it is preferable that the drive axis be in line contact with the moving body at two points.

In this case, a posture of the drive axis is stable.

In the drive device according to the embodiment of the technology, it is preferable that a metal plate abutting on the drive axis be attached to an inner wall surface of the insertion portion.

In this case, since the drive axis engages with an engagement surface portion of the metal plate which is attached to the inner wall surface of the insertion portion, friction on the drive axis and the inner wall surface of the insertion portion is reduced, and thus, drive performance and durability are improved.

In the drive device according to the embodiment of the technology, it is preferable that a pressing protrusion portion being in line contact or point contact with the drive axis be provided on the leaf spring.

In this case, the drive axis is in line contact or point contact with the pressing protrusion portion of the leaf spring, and thus, a direction biasing with respect to the drive axis by the leaf spring does not easily deviate.

In the drive device according to the embodiment of the technology, it is preferable that the press-down portion be formed in a protruding manner so as to cover a portion of an opening of the insertion portion.

In this case, the dislodgement of the leaf spring from the insertion portion caused by movements of the leaf spring in the insertion portion is prevented.

In the drive device according to the embodiment of the technology, it is preferable that the leaf spring be formed in a manner where an insertion-extraction direction thereof with respect to the insertion portion is set as a short direction, the press-down portion be positioned in the insertion portion, and pressed-down portions respectively pressed by the press-down portions be provided on at least one end portion of the leaf spring in the short direction and both end portions thereof in a longitudinal direction.

In this case, the press-down portion is provided inside the insertion portion, and thus, a thickness of the driven portion of the moving body in an optical axis direction becomes thin.

In the drive device according to the embodiment of the technology, it is preferable that the leaf spring be formed in a manner where an insertion-extraction direction thereof with respect to the insertion portion is set as a short direction, and pressed-down portions respectively pressed by the press-down portions be provided on a central portion of the leaf spring in the short direction and both end portions thereof in a longitudinal direction.

In this case, the press-down portion is provided inside the insertion portion, and the movements of the leaf spring are regulated by the press-down portion to be held by the moving body, and thus, the thickness of the driven portion of the moving body in the optical axis direction becomes thin.

In the drive device according to the embodiment of the technology, it is preferable that the leaf spring be formed in a manner where an insertion-extraction direction thereof with respect to the insertion portion is set as a short direction, and at least one end portion of the leaf spring in a longitudinal direction be bent to serve as a bent portion.

In this case, the leaf spring is prevented from tumbling down when the leaf spring is inserted into the insertion portion.

In the drive device according to the embodiment of the technology, it is preferable that a case body be provided having an axis insertion hole into which the drive axis is inserted and an attachment portion to which the piezoelectric element is attached.

In this case, the piezoelectric driver is held in the case body.

In the drive device according to the embodiment of the technology, it is preferable that a tapered surface extending in a circumferential direction be provided at an end portion of the drive axis on a side inserted into the insertion portion.

In this case, insertion of the drive axis with respect to the insertion portion is easily performed.

According to another embodiment of the present technology, there is provided a lens barrel inside of which a drive device driving an optical element is disposed. The drive device includes a moving body that has a driven portion in which an engagement holding portion is provided and an insertion portion is formed being open at least on one side thereof and an element holding portion which holds an optical element; a piezoelectric driver that has a piezoelectric element and a drive axis, in which the piezoelectric element expands and contracts when a voltage is applied thereto, the drive axis is displaced in an expansion-contraction direction of the piezoelectric element in response to the expansion-contraction of the piezoelectric element and moves the moving body, and the drive axis is inserted into the insertion portion; a leaf spring that is inserted into the insertion portion, is held by the moving body and urges the drive axis to the driven portion in a pressing direction; and in a state in which the leaf spring is inserted into the insertion portion, the leaf spring is elastically deformed in the insertion portion by inserting the drive axis which is inserted into the insertion portion, and the drive axis is pressed against the driven portion by the leaf spring, while the leaf spring is engaged with the engagement holding portion and held by the moving body.

In this case, in the lens barrel, the leaf spring for urging the drive axis of the piezoelectric driver to the driven portion side is held by the moving body without adopting any specific holding member such as a screw or a compression spring, and thus, it is not necessary to attach a holding member such as a screw or a compression spring.

According to still another embodiment of the present technology, there is provided an imaging apparatus having a lens barrel inside of which an optical element is disposed and a drive device driving the optical element. The drive device includes a moving body that has a driven portion in which an engagement holding portion is provided and an insertion portion is formed being open at least on one side thereof and an element holding portion which holds an optical element; a piezoelectric driver that has a piezoelectric element and a drive axis, in which the piezoelectric element expands and contracts when a voltage is applied thereto, the drive axis is displaced in an expansion-contraction direction of the piezoelectric element in response to the expansion-contraction of the piezoelectric element and moves the moving body, and the drive axis is inserted into the insertion portion; a leaf spring that is inserted into the insertion portion, is held by the moving body and urges the drive axis to the driven portion in a pressing direction; and in a state in which the leaf spring is inserted into the insertion portion, the leaf spring is elastically deformed in the insertion portion by inserting the drive axis which is inserted into the insertion portion, and the drive axis is pressed against the driven portion by the leaf spring, while the leaf spring is engaged with the engagement holding portion and held by the moving body.

In this case, in the imaging apparatus, the leaf spring for urging the drive axis of the piezoelectric driver to the driven portion side is held by the moving body without adopting any specific holding member such as a screw or a compression spring, and thus, it is not necessary to attach a holding member such as a screw or a compression spring.

According to the embodiments of the present technology, since a leaf spring for urging a drive axis of a piezoelectric driver to a driven portion side is held by a moving body without adopting any specific holding member such as a screw or a compression spring and it is not necessary to attach a holding member such as a screw or a compression spring, it is possible to shorten the time for assembling a drive device, and thus, it is possible to improve efficiency in assembling the drive device.

### BRIEF DESCRIPTION OF THE DRAWINGS

FIGS. 1 to 17 commonly illustrate an embodiment according to the present technology, and FIG. 1 is a perspective view of an imaging apparatus;

FIG. 2 is another perspective view of the imaging apparatus illustrated in a state when it is viewed from an angle different from that of FIG. 1;

FIG. 3 is a perspective view of a lens barrel;

FIG. 4 is an exploded perspective view of a drive device;

FIG. 5 is an enlarged perspective view illustrating a driven portion and a metal plate;

FIG. 6 is an enlarged exploded-perspective view illustrating the driven portion and the metal plate;

FIG. 7 is a perspective view illustrating a state in which the drive device is assembled;

FIGS. 8 to 13 commonly describe movements of a leaf spring when a drive axis is inserted into an insertion portion, and FIG. 8 is an enlarged cross-sectional view illustrating a state in which the leaf spring is inserted into the insertion portion;

FIG. 9 is an enlarged plan view illustrating the state in which the leaf spring is inserted into the insertion portion;

FIG. 10 is an enlarged cross-sectional view illustrating an appearance of the drive axis being inserted into the insertion portion;

FIG. 11 is an enlarged plan view illustrating another appearance of the drive axis being inserted into the insertion portion;

FIG. 12 is another enlarged cross-sectional view illustrating a state in which the drive axis is inserted into the insertion portion;

FIG. 13 is another enlarged plan view illustrating a state in which the drive axis is inserted into the insertion portion;

FIG. 14 is an enlarged exploded-perspective view illustrating a first modification example of the leaf spring and a moving body;

FIG. 15 is an enlarged cross-sectional view illustrating a state in which the leaf spring according to the first modification example is inserted into the insertion portion;

FIG. 16 is an enlarged exploded-perspective view illustrating a second modification example of the leaf spring and the moving body; and

FIG. 17 is an enlarged cross-sectional view illustrating a state in which the leaf spring according to the second modification example is inserted into the insertion portion.

### DETAILED DESCRIPTION OF EMBODIMENTS

Hereinafter, a drive device, a lens barrel and an imaging apparatus according to an embodiment of the present technology will be described with reference to the attached drawings.

In the below-described embodiment, the imaging apparatus of the present technology is applied to a still camera, the lens barrel of the present technology is applied to a lens barrel included in the still camera, and the drive device of the present technology is applied to a drive device of an optical element which is driven inside the lens barrel.

A scope of the present technology is not limited to the still camera, the lens barrel included in the still camera, and the drive device of the optical element which is driven inside the lens barrel. For example, the present technology can be widely applied to various imaging apparatuses which are embedded in a video camera or other equipment, lens barrels which are included in those various imaging apparatuses, and drive devices which are provided in those various imaging apparatuses.

In the below description, the forward, rearward, upward, downward, left and right directions indicate the directions viewed from a photographer when capturing an image with a still camera. Therefore, the forward direction is toward a subject side, and the rearward direction is toward the photographer side.

The forward, rearward, upward, downward, left and right directions are for convenience of the description, and the embodiment of the present technology is not limited to those directions.

The embodiment will be described in the following order:
1. Configuration of Imaging Apparatus
2. Configuration of Lens Barrel
3. Configuration of Drive Device
4. Assembly of Drive Device
5. Operation of Drive Device
6. Modification Example
7. Conclusion
8. The Present Technology

1. Configuration of Imaging Apparatus

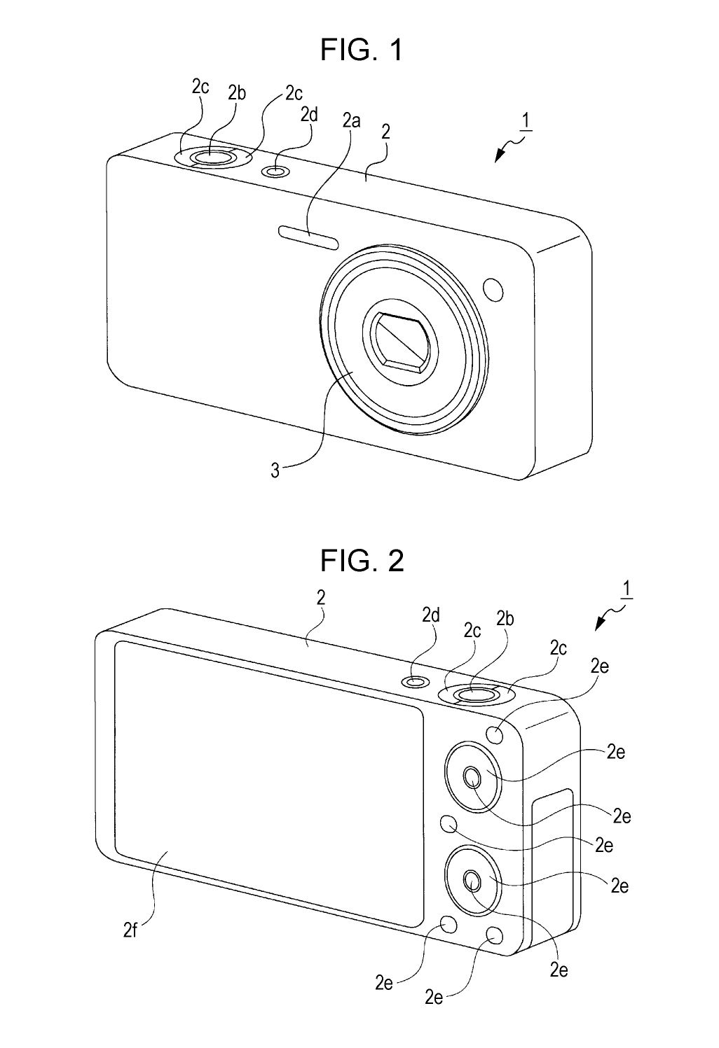

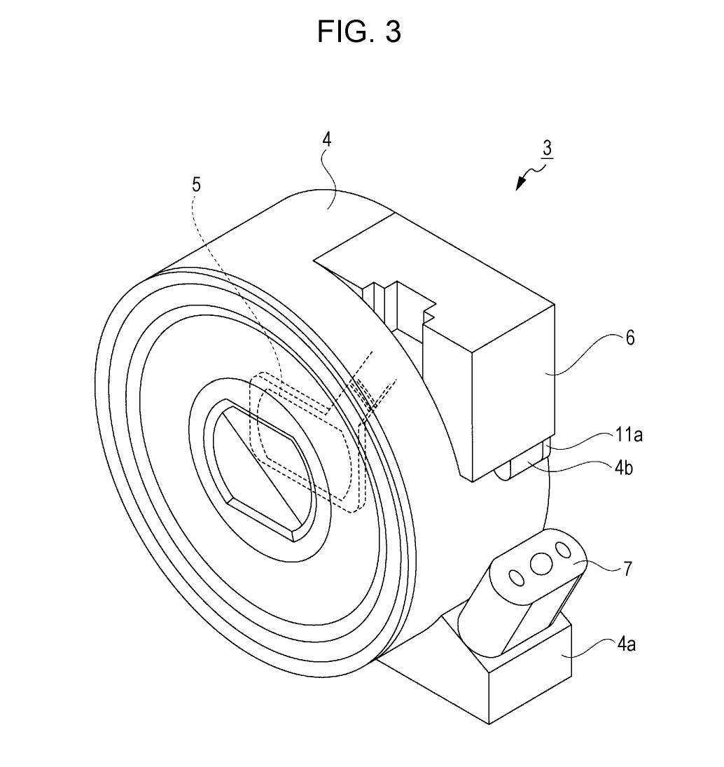

First, a configuration of the imaging apparatus according to the present technology will be described (see FIGS. 1 and 2).

As illustrated in FIG. 1, for example, an imaging apparatus 1 has a flat rectangular camera casing 2 and a lens barrel 3 which is supported by the camera casing 2 being movable (capable of elongating and shortening) in an optical axis direction. The imaging apparatus 1 is a so-called collapsible-type imaging apparatus in which the lens barrel 3 is accommodated in the camera casing 2 when it is not capturing an image, and the lens barrel 3 projects frontward from the camera casing 2 when capturing an image. The lens barrel 3 is elongated and shortened between an accommodation position to be accommodated in the camera casing 2 and an extension position to project frontward from the camera casing 2.

The imaging apparatus 1 is not necessarily a collapsible type. The imaging apparatus 1 may be a type in which an interchangeable lens is mounted on the camera casing 2 or a type in which the lens barrel 3 is not elongated and shortened.

Each of necessary portions is disposed inside and outside the camera casing 2. A flash 2a is provided on a forward surface of the camera casing 2. A shutter button 2b, zoom switches 2c and a power button 2d are provided on an upper surface of the camera casing 2. In addition, as illustrated in FIG. 2, various operational buttons 2e, 2e and other various buttons, and a display 2f are provided on a rearward surface of the camera casing 2.

2. Configuration of Lens Barrel

Next, a configuration of the lens barrel 3 will be described.

As illustrated in FIG. 3, the lens barrel 3 has a barrel main body 4, a zoom lens 5 which is the optical element disposed inside the barrel main body 4, and a drive device 6 of which a portion is disposed inside the barrel main body 4. A motor attachment protrusion portion 4a and a device attachment protrusion portion 4b are provided in the barrel main body 4. A motor 7 which elongates and shortens the lens barrel 3 between the accommodation position and the extension position is attached to the motor attachment protrusion portion 4a.

3. Configuration of Drive Device

Subsequently, a configuration of the drive device 6 will be described.

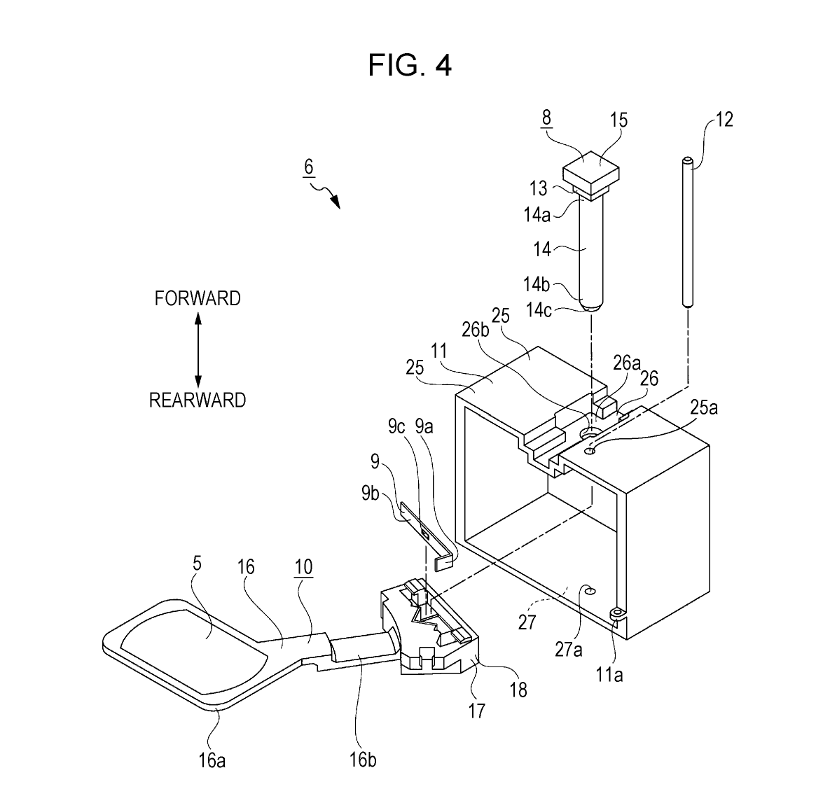

As illustrated in FIG. 4, the drive device 6 has a piezoelectric driver 8, a leaf spring 9, a moving body 10, a case body 11 and an auxiliary axis 12.

The piezoelectric driver 8 has a rectangular parallelepiped-shaped piezoelectric element 13 which expands and contracts in the optical axis direction when a voltage is applied thereto, a drive axis 14 which is displaced in the optical axis direction (axial direction) in response to the expansion-contraction of the piezoelectric element 13 while having the optical axis direction as an axial direction, and a weight 15 which is formed in a rectangular parallelepiped shape for example. One end portion of the drive axis 14 in the axial direction is referred to as an attached end portion 14a, and the other end portion thereof in the axial direction is referred to as an insertion end portion 14b. The attached end portion 14a of the drive axis 14 is attached to a surface on one side of the piezoelectric element 13 in an expansion-contraction direction, and the weight 15 is attached to a surface on the other side of the piezoelectric element 13 in an expansion-contraction direction. A tapered surface 14c which extends in a circumferential direction and of which a diameter becomes smaller closer to the tip is formed at a tip portion of the insertion end portion 14b of the drive axis 14.

The leaf spring 9, for example, is formed of metal in a rectangular plate shape, and one end portion thereof in a longitudinal direction is formed in a shape of being bent at an angle of substantially 90 degrees. A bent portion of the leaf spring 9 is referred to as a bent portion 9a, and a portion other than the bent portion 9a is referred to as a pressing portion 9b. A pressing protrusion portion 9c which protrudes in a direction where the bent portion 9a is bent and engages with the drive axis 14 is provided in a substantially central portion of the pressing portion 9b in the longitudinal direction. The bent portion 9a may be bent in a direction 180 degrees opposite to the protruding direction of the pressing protrusion portion 9c. In addition, a front surface of the pressing protrusion portion 9c forms an arc shape in a short direction of the leaf spring 9.

The moving body 10 moves in the optical axis direction by a driving force of the piezoelectric driver 8 and has an element holding portion 16 which holds a zoom lens 5 and a driven portion 17 into which a portion of the drive axis 14 and the leaf spring 9 are inserted. The element holding portion 16 and the driven portion 17 are integrally formed, for example. As long as the element holding portion 16 and the driven portion 17 are set to integrally move by the driving force of the piezoelectric driver 8, the element holding portion 16 and the driven portion 17 may be configured to be formed of different members.

The element holding portion 16 is configured to have a holding frame 16a and an arm portion 16b. The holding frame 16a holds the zoom lens 5. The arm portion 16b extends from the holding frame 16a in a direction orthogonal to the optical axis direction, and an end portion on a side opposite to the holding frame 16a is connected to the driven portion 17.

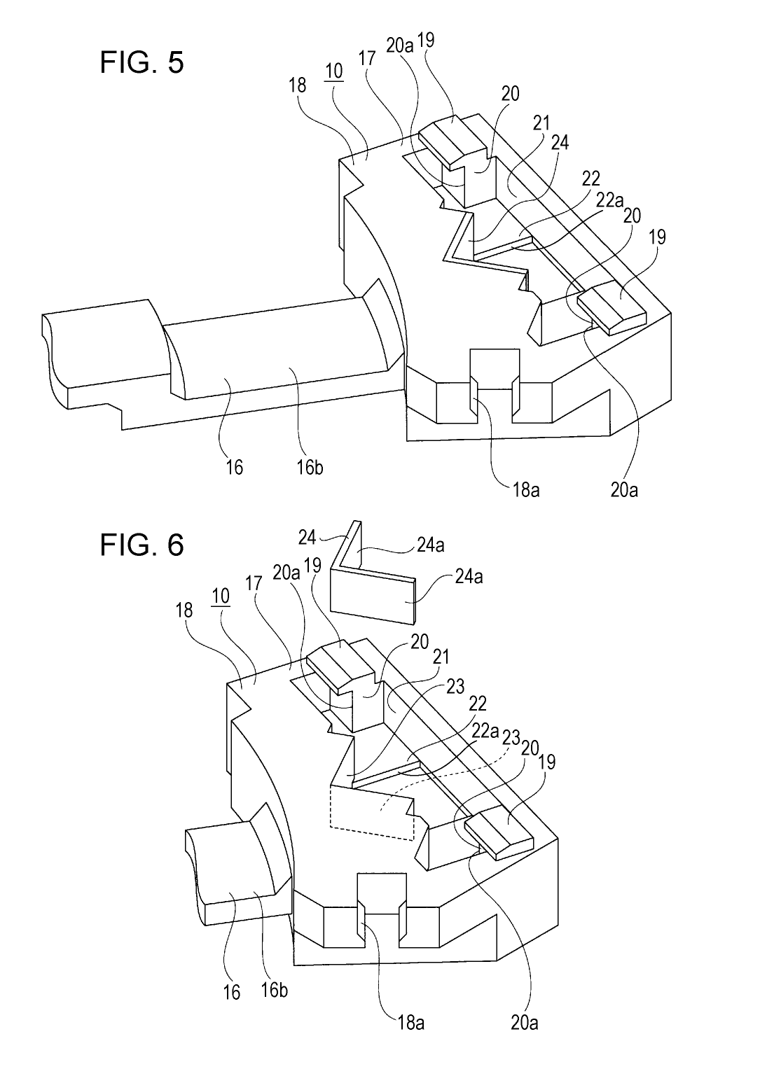

As illustrated in FIG. 5, the driven portion 17 has a base portion 18, press-down portions 19 and 19, and engagement holding portions 20 and 20.

The base portion 18 is formed in a substantially rectangular parallelepiped shape in a substantially long circumferential direction using the optical axis as a standard. An insertion portion 21 opened frontward (subject side in optical axis direction) and shaped to extend in a longitudinal direction of the base portion 18 is formed in the base portion 18. In addition, a guided groove 18a extending in the optical axis direction is formed on an outer peripheral portion of the base portion 18, and the auxiliary axis 12 is inserted into the guided groove 18a.

A rearward surface portion of the insertion portion 21 is provided as a floor portion 22. An insertion hole 22a into which the drive axis 14 is inserted while being larger than a diameter of the drive axis 14 is formed in a substantially central portion of the floor portion 22.

As illustrated in FIG. 6, some portions of an inner wall surface of the insertion portion 21 on the arm portion 16b side form oblique surfaces 23 and 23. The oblique surfaces 23 and 23 are continuously formed in a longitudinal direction of the insertion portion 21 to be in a V-shape with an angle of substantially 90 degrees. A V-shaped metal plate 24 is attached to the oblique surfaces 23 and 23. The metal plate 24 is configured to have engagement surface portions 24a and 24a which are respectively in close contact with the oblique surfaces 23 and 23.

The press-down portions 19 and 19 protrude from an end portion on the outer side of the base portion 18 in the short direction and both end portions in the longitudinal direction thereof to the arm portion 16b side, and are provided so as to cover a portion of the insertion portion 21.

The engagement holding portions 20 and 20 are provided on inner sides of the base portion 18 while continuously pressing the press-down portions 19 and 19 respectively. The engagement holding portion 20 has a corner portion formed to be a substantially right angle while being convex-shaped toward the inner side of the insertion portion 21, and a ridge line 20a of the corner portion forms a straight line extending in the optical axis direction.

As illustrated in FIG. 4, the case body 11 is formed in a substantially a box shape open toward the optical axis side. An auxiliary axis insertion hole 25a is formed on a forward surface portion 25 of the case body 11, a concave-shaped attachment portion 26 opened frontward is formed on a substantially central portion of the forward surface portion 25. An element attachment concave portion 26a to which the piezoelectric element 13 and the weight 15 of the piezoelectric driver 8 are attached and an axis insertion hole 26b into which the drive axis 14 of the piezoelectric driver 8 is inserted are formed in the attachment portion 26.

An auxiliary axis reception hole 27a into which the auxiliary axis 12 is inserted is formed on a rearward surface portion 27 of the case body 11. In addition, an attached protrusion portion 11a is provided in the case body 11. The case body 11 of which the attached protrusion portion 11a is attached to a device attachment protrusion portion 4b of the lens barrel 3 using a fastening screw and the like is held by the barrel main body 4 (see FIG. 3).

In the auxiliary axis 12, the optical axis direction is set as an axial direction. The auxiliary axis 12 functions to guide the moving body 10 in the optical axis direction. In addition, the auxiliary axis 12 functions to regulate rotations of the moving body 10 in an optical axis rotation direction with respect to the drive axis 14.

4. Assembly of Drive Device

Next, a procedure of assembling the drive device 6 will be described.

First, as illustrated in FIG. 4, the leaf spring 9 is inserted into the insertion portion 21 which is formed in the driven portion 17 of the moving body 10 so as to cause the short direction to become a forward-rearward direction. In this case, one end portion of the leaf spring 9 in the longitudinal direction is formed as the bent portion 9a, and thus, the leaf spring 9 is prevented from tumbling down when the leaf spring 9 is inserted into the insertion portion 21. Therefore, it is possible to improve work efficiency.

Next, the driven portion 17 of the moving body 10 is disposed inside the case body 11. Moreover, the auxiliary axis 12 is sequentially inserted into the auxiliary axis insertion hole 25a of the case body 11, the guided groove 18a of the moving body 10, and the auxiliary axis reception hole 27a of the case body 11. The auxiliary axis 12 is fixed to the case body 11 in a state of being inserted into the auxiliary axis insertion hole 25a and the auxiliary axis reception hole 27a. In a state in which the auxiliary axis 12 is fixed to the case body 11, the moving body 10 is supported by the auxiliary axis 12.

Subsequently, the drive axis 14 of the piezoelectric driver 8 is inserted into the axis insertion hole 26b of the case body 11 and inserted into the insertion portion 21 of the moving body 10. In this case, the drive axis 14 is inserted between the metal plate 24 and the leaf spring 9 of the driven portion 17. Since the moving body 10 is allowed to only rotate with the auxiliary axis 12 as a fulcrum, an insertion position with respect to the insertion portion 21 of the drive axis 14 is easily determined so that the drive axis 14 can be easily inserted between the metal plate 24 and the leaf spring 9. When the drive axis 14 is inserted into the insertion portion 21, the leaf spring 9 is elastically deformed. However, an operation of the leaf spring 9 in this case will be described below. The moving body 10 is regulated in its rotations with respect to the drive axis 14 by inserting the drive axis 14 and the auxiliary axis 12.

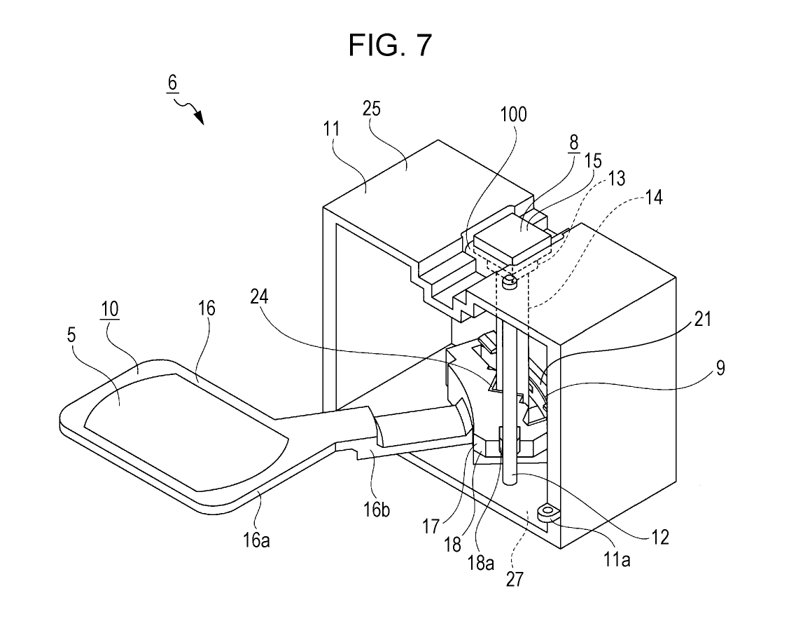

Lastly, as illustrated in FIG. 7, the piezoelectric element 13 and the weight 15 of the piezoelectric driver 8 are attached to the element attachment concave portion 26a of the case body 11 using an adhesive agent 100.

As described above, there are provided the case body 11 having the axis insertion hole 26b into which the drive axis 14 of the piezoelectric driver 8 is inserted and the attachment portion 26 to which the piezoelectric element 13 and the weight 15 are attached so that the piezoelectric driver 8 is held by the case body 11, and thus, it is possible to achieve a stable drive state of the piezoelectric driver 8.

In addition, since unitization of the drive device 6 can be achieved by providing the case body 11, it is possible to improve the efficiency in assembling the drive device 6 to the lens barrel 3.

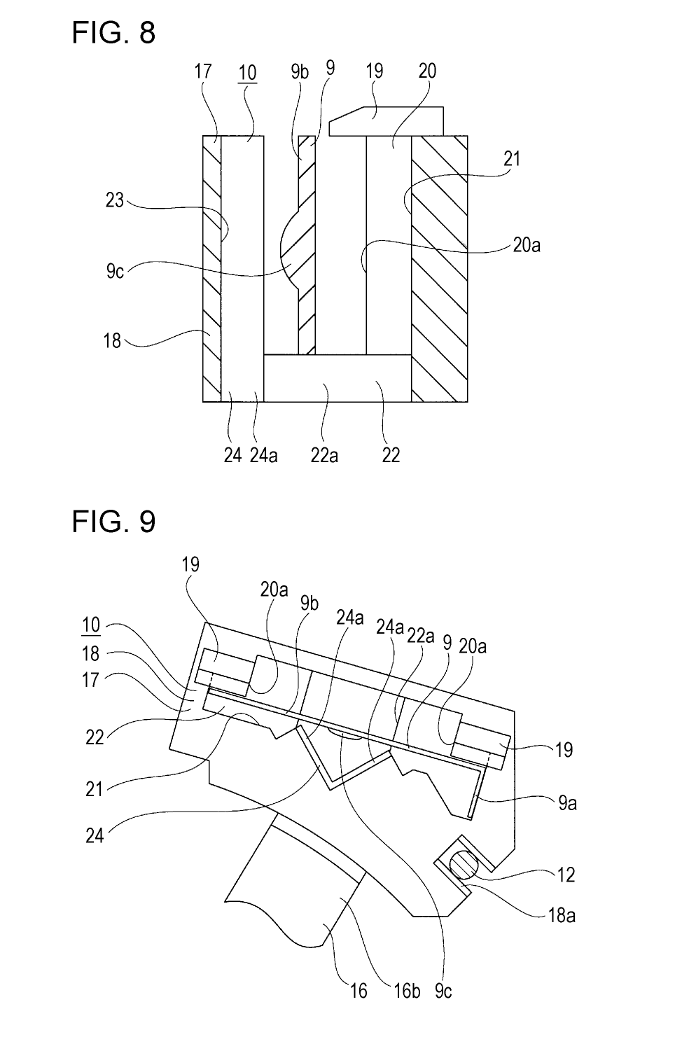

Hereinafter, using FIGS. 8 to 13, the operation of the leaf spring 9 will be described when the drive axis 14 of the piezoelectric driver 8 is inserted into the insertion portion 21 of the moving body 10.

As illustrated in FIGS. 8 and 9, the leaf spring 9 inserted into the insertion portion 21 of the moving body 10 is positioned inside the insertion portion 21 in its entirety.

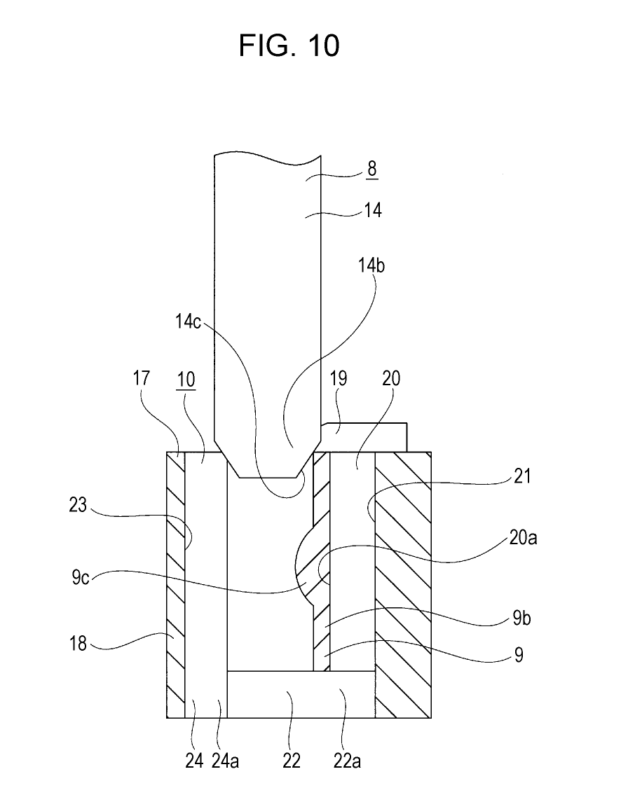

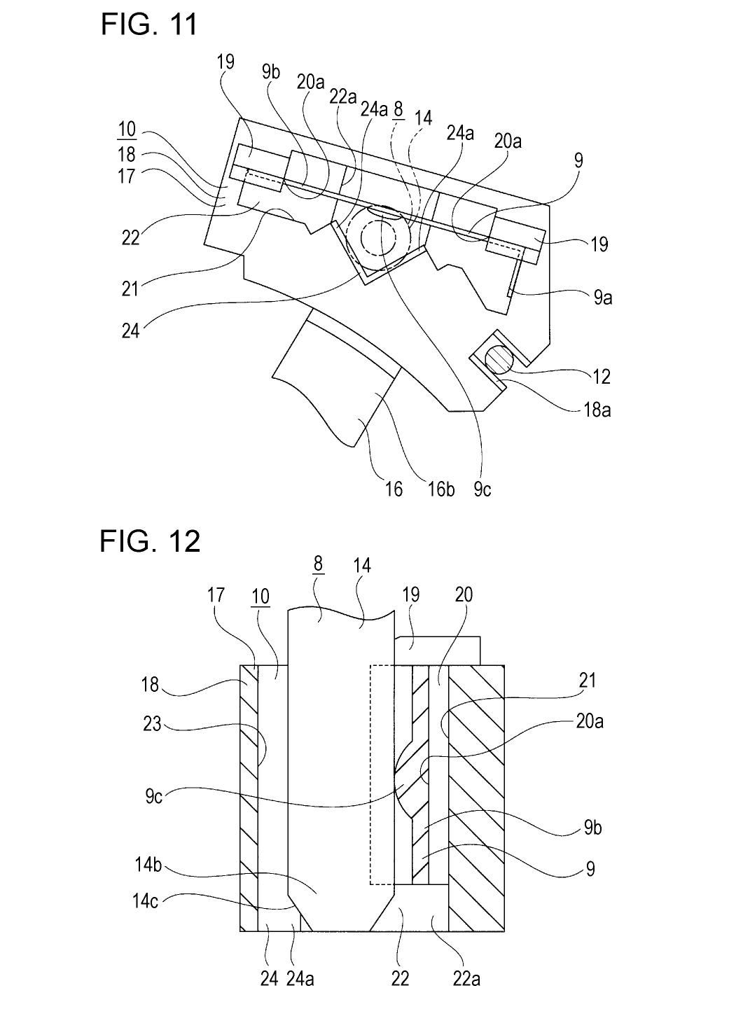

When the drive axis 14 is inserted between the metal plate 24 and the leaf spring 9 of the driven portion 17, as illustrated in FIGS. 10 and 11, the drive axis 14 is engaged with two points of one end edge in the metal plate 24 and one end edge in the leaf spring 9, and the leaf spring 9 is pressed against the drive axis 14 in response to the insertion of the drive axis 14 with respect to the insertion portion 21 to be moved in a direction to become closer to the engagement holding portions 20 and 20 of the driven portion 17, and thus, both end portions in the longitudinal direction are respectively in contact with the engagement holding portions 20 and 20. As described above, since the tapered surface 14c is formed at the tip portion of the insertion end portion 14b of the drive axis 14, the drive axis 14 is easily inserted into the insertion portion 21. Therefore, it is possible to improve the efficiency of the insertion.

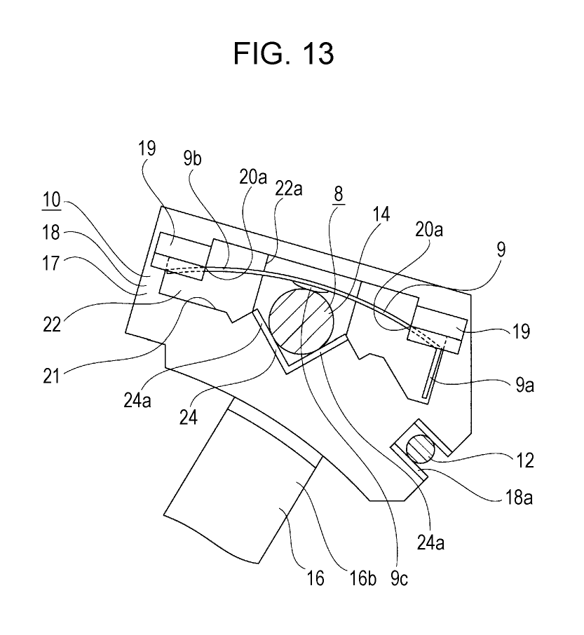

Furthermore, if the drive axis 14 is inserted into the insertion portion 21, as illustrated in FIGS. 12 and 13, since both end portions of the leaf spring 9 in the longitudinal direction are respectively in contact with the engagement holding portions 20 and 20, the substantially central portion thereof in the longitudinal direction is pressed against the drive axis 14, thereby being elastically deformed so as to be set along an arc of the outer peripheral surface of the drive axis 14. In a state in which the drive axis 14 is inserted into the insertion portion 21 to cause the leaf spring 9 to be elastically deformed, the pressing protrusion portion 9c of the leaf spring 9 is in point contact with the drive axis 14, and both of the end portions thereof in the longitudinal direction are respectively in line contact with the ridge lines 20a and 20a of the engagement holding portions 20 and 20.

In this case, the drive axis 14 receives a force of the elastically deformed leaf spring 9 to elastically return from the pressing protrusion portion 9c which becomes a biasing point, thereby being pressed against the engagement surface portions 24a and 24a of the metal plate 24. Since the drive axis 14 engages with the metal plate 24 at two points spaced apart from each other and also engages with the pressing protrusion portion 9c of the leaf spring 9, the drive axis 14 engages with the leaf spring 9 and the moving body 10 at three points spaced apart from each other on a surface orthogonal to the optical axis, thereby being positioned on the surface orthogonal to the optical axis.

In this state, since the rearward surface of the leaf spring 9 is in contact with the floor portion 22 and both end portions of the forward surface of the leaf spring 9 in the longitudinal direction engage with the press-down portions 19 and 19 of the driven portion 17 to be pressed, dislodgement of the leaf spring 9 from the insertion portion 21 is prevented. Therefore, since the leaf spring 9 does not dislodge from the insertion portion 21 as long as the drive axis 14 is not withdrawn from the insertion portion 21, it is possible to secure a stable holding state with respect to the leaf spring 9 of the moving body 10 even if a vibration or dropping of the imaging apparatus 1 occurs.

In addition, since the leaf spring 9 engages with the engagement holding portions 20 and 20 of the driven portion 17 at two points spaced apart from each other in the longitudinal direction interposing the pressing protrusion portion 9c therebetween, distortion does not easily occur in the leaf spring 9 and a posture of the leaf spring 9 is stable, and thus, it is possible to achieve a stable drive state of the moving body 10.

Moreover, since the leaf spring 9 engages with the engagement holding portions 20 and 20 at both end portions in the longitudinal direction, the leaf spring 9 can be deformed by a small force, and thus, the drive axis 14 can be easily inserted into the insertion portion 21.

Furthermore, since both end portions of the leaf spring 9 respectively engage with the ridge lines 20a and 20a of the engagement holding portions 20 and 20 of the driven portion 17 by being in line contact therewith, the leaf spring 9 does not easily clatter and is disposed in the insertion portion 21 in a stable state, and thus, it is possible to achieve the stable drive state of the moving body 10.

In addition, since the drive axis 14 engages at two points with the engagement surface portions 24a and 24a of the metal plate 24 attached to the oblique surfaces 23 and 23, a posture of the drive axis 14 is stable, and thus, it is possible to efficiently transfer the displacement of the drive axis 14 to the moving body 10.

The above-described example illustrates that the metal plate 24 is attached to the oblique surfaces 23 and 23. However, without attaching the metal plate 24 to the oblique surfaces 23 and 23, the drive axis 14 may be caused to engage with the oblique surfaces 23 and 23 at two points. In this case as well, it is possible to acquire the similar effect.

Moreover, since the drive axis 14 engages with the engagement surface portions 24a and 24a of the metal plate 24 attached to the oblique surfaces 23 and 23 of the insertion portion 21, friction on the drive axis 14 and the oblique surfaces 23 and 23 is reduced, and thus, it is possible to achieve a long-lasting drive device 6.

In addition, since drive axis 14 is in point contact with the pressing protrusion portion 9c of the leaf spring 9, a direction biasing with respect to the drive axis 14 by the leaf spring 9 does not easily deviate, and thus, it is possible to achieve a stable operation of the drive device 6. Meanwhile, the drive axis 14 may be configured to be in line contact with the leaf spring 9. In a case where the drive axis 14 and the pressing protrusion portion 9c are in line contact with each other, it is possible to acquire the similar effect as well.

Moreover, the press-down portions 19 and 19 of the driven portion 17 are provided to cover a portion of the opening of the insertion portion 21 so that the leaf spring 9 only moves within the insertion portion 21, and thus, it is possible to prevent the dislodgement of the leaf spring 9 from the insertion portion 21 after the assembling. Therefore, it is possible to improve workability in assembling the drive device 6.

5. Operation of Drive Device

Subsequently, the operation of the drive device 6 will be described. In the drive device 6, as described below, a rapid voltage change and a moderate voltage change are alternately performed with respect to the piezoelectric element 13, thereby causing a driving force with respect to the moving body 10.

If magnitude of an applied voltage is quickly changed so as to cause the voltage change to be rapid with respect to the piezoelectric element 13, since the driving force of the drive axis 14 displaced in response to the expansion-contraction of the piezoelectric element 13 exceeds a static friction force generated in the drive axis 14, the moving body 10 is not possible to follow the displacement of the drive axis 14. Therefore, the drive axis 14 is displaced with respect to the moving body 10.

Meanwhile, if the magnitude of an applied voltage is slowly changed so as to cause the voltage change to be moderate with respect to the piezoelectric element 13, since the driving force of the drive axis 14 displaced in response to the expansion-contraction of the piezoelectric element 13 does not exceed the static friction force generated in the drive axis 14, the moving body 10 moves following the displacement of the drive axis 14.

If the above-described rapid voltage change and the moderate voltage change are alternately performed, and a direction of the rapid voltage change and a direction of the moderate voltage change are reversed, it is possible to move the moving body 10 by the driving force of the piezoelectric driver 8. In this case, if a combination of a speed of the voltage changes (rapid change and moderate change) and a direction of the voltage changes are reversed, it is possible to cause a moving direction of the moving body 10 to change to the opposite direction, and thus, the moving body 10 and the zoom lens 5 held by the moving body 10 move forward or rearward.

6. Modification Example

Hereinafter, a modification example of the leaf spring and the moving body will be described.

6-1. First Modification Example of Leaf Spring and Moving Body

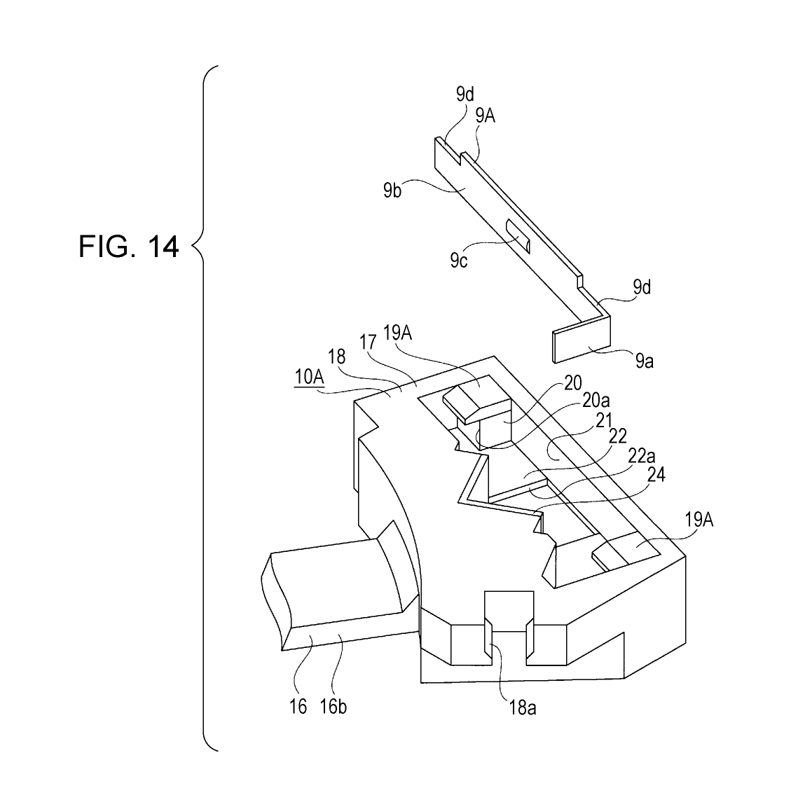

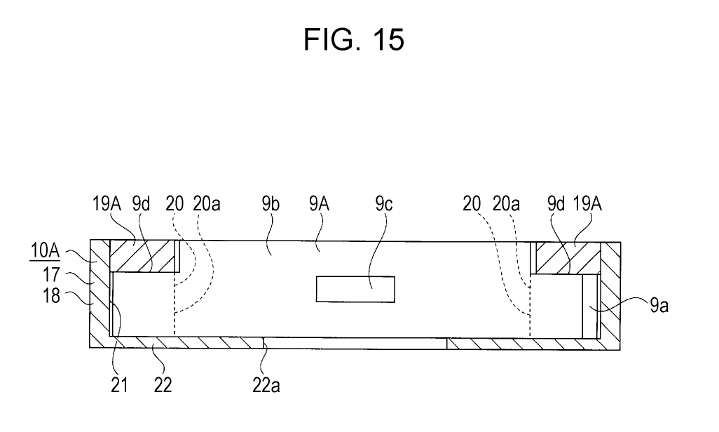

As illustrated in FIGS. 14 and 15, in a leaf spring 9A according to a first modification example, notch-shaped pressed-down portions 9d and 9d are formed at both end portions on a front end side portion of the leaf spring 9A in the longitudinal direction. In addition, press-down portions 19A and 19A of a moving body 10A according to the first modification example protrude from an end portion on an outer side in the short direction and both end portions in the longitudinal direction of the base portion 18 toward the arm portion 16b side, thereby being positioned inside the insertion portion 21 in its entirety. The press-down portions 19A and 19A may be integrally formed with the base portion 18 of the moving body 10A or may be configured to be formed of different members.

When the drive axis 14 of the piezoelectric driver 8 is inserted into the insertion portion 21 of the moving body 10, the pressed-down portions 9d and 9d of the leaf spring 9A respectively engage with the press-down portions 19A and 19A of the moving body 10A so that a rearward surface of the leaf spring 9A is in a contact state with the floor portion 22 of the driven portion 17, and the leaf spring 9A is held by the moving body 10A.

In this manner, the notch-shaped pressed-down portions 9d and 9d are formed in the leaf spring 9A, the press-down portions 19A and 19A are provided inside the insertion portion 21, and movements of the leaf spring 9A are regulated by the press-down portions 19A and 19A and the floor portion 22 to be held by the moving body 10A, and thus, it is possible to cause a thickness of the driven portion 17 of the moving body 10A in the optical axis direction to be thin. Therefore, it is possible to reduce the size of the drive device 6.

6-2. Second Modification Example of Leaf Spring and Moving Body

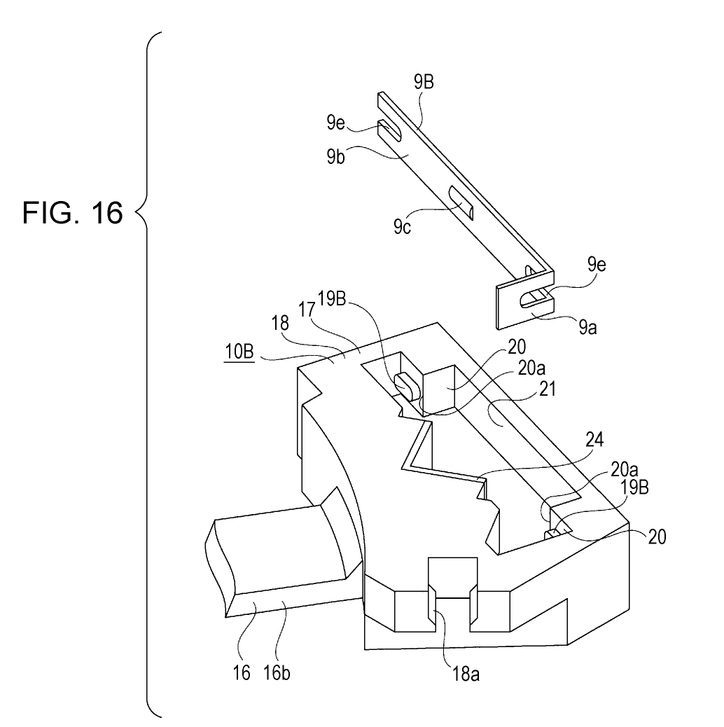

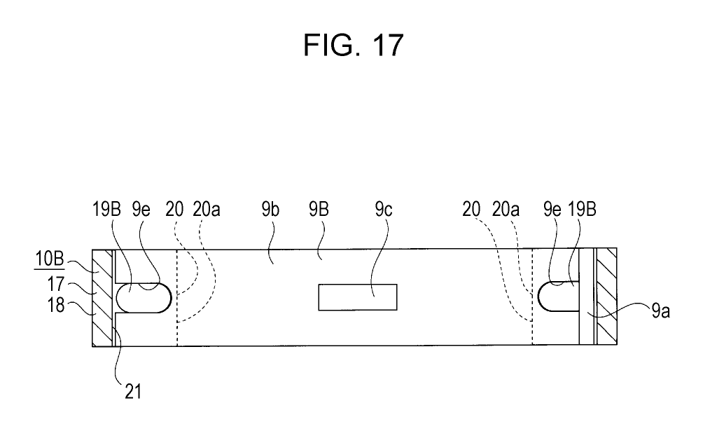

As illustrated in FIGS. 16 and 17, in a leaf spring 9B according to a second modification example, notch-shaped or hole-shaped pressed-down portions 9e and 9e are formed at both end portions in the longitudinal direction and in a substantially central portion in the short direction.

Protruding press-down portions 19B and 19B are provided on a surface facing the element holding portion 16 side in the engagement holding portions 20 and 20 of a moving body 10B. Therefore, the press-down portions 19B and 19B are positioned inside the insertion portion 21 in its entirety. The press-down portions 19B and 19B may be integrally formed with the base portion 18 of the moving body 10B or may be configured to be formed of different members. In addition, the moving body 10B is provided with no floor portion 22 which is provided in the moving body 10.

When the drive axis 14 of the piezoelectric driver 8 is inserted into the insertion portion 21 of the moving body 10, the pressed-down portions 9e and 9e of the leaf spring 9B respectively engage with the press-down portions 19B and 19B of the moving body 10B. In this state, movements of the leaf spring 9B in the optical axis direction are regulated by the press-down portions 19B and 19B, and the leaf spring 9B is held by the moving body 10B.

In this manner, the notch-shaped or hole-shaped pressed-down portions 9e and 9e are formed in the leaf spring 9B, the press-down portions 19B and 19B are provided inside the insertion portion 21, and movements of the leaf spring 9B are regulated by the press-down portions 19B and 19B to be held by the moving body 10B, and thus, it is possible to cause a thickness of the driven portion 17 of the moving body 10B in the optical axis direction to be thin. Therefore, it is possible to reduce the size of the drive device 6.

The pressed-down portions 9e and 9e of the leaf spring 9B may be formed in a protruding manner, and furthermore, the press-down portions 19B and 19B of the moving body 10B may be formed as holes or grooves into which the pressed-down portions 9e and 9e are inserted.

7. Conclusion

As described above, in the drive device 6, the lens barrel 3 and the imaging apparatus 1, the leaf springs 9, 9A, 9B for urging the drive axis 14 of the piezoelectric driver 8 to the moving bodies 10, 10A, 10B side are held by the moving bodies 10, 10A, 10B without adopting any specific holding member such as a screw or a compression spring. Therefore, it is not necessary to attach a holding member such as a screw or a compression spring, thus it is possible to shorten the time for assembling a drive device 6, and it is possible to improve efficiency in assembling the drive device 6. In addition, since it is not necessary to provide a fastening screw hole or an attachment portion for attaching the holding member such as a screw or a compression spring, it is possible to reduce the size of the drive device 6 and reduce the number of components thereof.

Moreover, the leaf springs 9, 9A, 9B can be detached from the driven portion 17 by pulling out the drive axis 14 from the insertion portion 21 so that maintenance of the drive device 6 can be easily performed. In addition, since it is possible to reuse the leaf springs 9, 9A, 9B and the moving bodies 10, 10A, 10B, it is possible to reduce the cost of the maintenance.

Furthermore, it is possible to assemble the drive device 6 by inserting the leaf springs 9, 9A, 9B and the drive axis 14 of the piezoelectric driver 13 into the insertion portion 21 of the moving bodies 10, 10A, 10B, and thus, it is possible to reduce the process in the assembling.

In the above-described example, the present technology is applied to a lens movement mechanism adopting a zoom lens as the optical element. However, the present technology can also be applied to a movement mechanism to move another lens such as a focus lens, an image stabilization mechanism, an iris mechanism or the like.

In addition, the above-described example illustrates that the optical element is moved in the optical axis direction. However, the present technology can also be applied to an example in which the optical element is moved in a direction orthogonal to the optical axis direction. In this case, a mechanism changing a direction where the piezoelectric driver 8 and the like are disposed or converting the driving force of the drive axis 14 into a different direction may be mounted.

8. The Present Technology

The present technology can be configured as follows:
(1) A drive device includes a moving body that has a driven portion in which an engagement holding portion is provided and an insertion portion is formed being open at least on one side thereof and an element holding portion which holds an optical element; a piezoelectric driver that has a piezoelectric element and a drive axis, in which the piezoelectric element expands and contracts when a voltage is applied thereto, the drive axis is displaced in an expansion-contraction direction of the piezoelectric element in response to the expansion-contraction of the piezoelectric element and moves the moving body, and the drive axis is inserted into the insertion portion; and a leaf spring that is inserted into the insertion portion, is held by the moving body and urges the drive axis to the driven portion in a pressing direction. In a state in which the leaf spring is inserted into the insertion portion, the leaf spring is elastically deformed in the insertion portion by inserting the drive axis which is inserted into the insertion portion, and the drive axis is pressed against the driven portion by the leaf spring, while the leaf spring is engaged with the engagement holding portion and held by the moving body.
(2) In the drive device according to (1), a press-down portion may be provided in the driven portion, and in a state in which the leaf spring is held by the moving body, dislodgement of the leaf spring with respect to the insertion portion may be regulated by the press-down portion.
(3) In the drive device according to (1) or (2), the leaf spring may be formed in a manner where an insertion-extraction direction thereof with respect to the insertion portion is set as a short direction, and the engagement holding portions may be provided being spaced apart from each other in a longitudinal direction of the leaf spring.
(4) In the drive device according to (3), two of the engagement holding portions may respectively engage with both end portions of the leaf spring in the longitudinal direction.
(5) In the drive device according to (3) or (4), two of the engagement holding portions may engage with the leaf spring by being in line contact therewith.
(6) In the drive device according to any one of (1) to (5), the drive axis may be in line contact with the moving body at two points.
(7) In the drive device according to any one of (1) to (6), a metal plate abutting on the drive axis may be attached to an inner wall surface of the insertion portion.
(8) In the drive device according to any one of (1) to (7), a pressing protrusion portion being in line contact or point contact with the drive axis may be provided on the leaf spring.
(9) In the drive device according to any one of (2) to (8), the press-down portion may be formed in a protruding manner so as to cover a portion of an opening of the insertion portion.
(10) In the drive device according to any one of (2) to (9), the leaf spring may be formed in a manner where an insertion-extraction direction thereof with respect to the insertion portion is set as a short direction, the press-down portion may be positioned in the insertion portion, and pressed-down portions respectively pressed by the press-down portions may be provided on at least one end portion of the leaf spring in the short direction and both end portions thereof in a longitudinal direction.
(11) In the drive device according to any one of (2) to (9), the leaf spring may be formed in a manner where an insertion-extraction direction thereof with respect to the insertion portion is set as a short direction, and pressed-down portions respectively pressed by the press-down portions may be provided on a central portion of the leaf spring in the short direction and both end portions thereof in a longitudinal direction.
(12)In the drive device according to any one of (1) to (11), the leaf spring may be formed in a manner where an insertion-extraction direction thereof with respect to the insertion portion is set as a short direction, and at least one end portion of the leaf spring in a longitudinal direction may be bent to serve as a bent portion.
(13) In the drive device according to any one of (1) to (12), a case body may be provided having an axis insertion hole into which the drive axis is inserted and an attachment portion to which the piezoelectric element is attached.
(14)In the drive device according to any one of (1) to (13), a tapered surface extending in a circumferential direction may be provided at an end portion of the drive axis on a side inserted into the insertion portion.
(15) In a lens barrel inside of which a drive device driving an optical element is disposed, the drive device includes a moving body that has a driven portion in which an engagement holding portion is provided and an insertion portion is formed being open at least on one side thereof and an element holding portion which holds an optical element; a piezoelectric driver that has a piezoelectric element and a drive axis, in which the piezoelectric element expands and contracts when a voltage is applied thereto, the drive axis is displaced in an expansion-contraction direction of the piezoelectric element in response to the expansion-contraction of the piezoelectric element and moves the moving body, and the drive axis is inserted into the insertion portion; a leaf spring that is inserted into the insertion portion, is held by the moving body and urges the drive axis to the driven portion in a pressing direction; and in a state in which the leaf spring is inserted into the insertion portion, the leaf spring is elastically deformed in the insertion portion by inserting the drive axis which is inserted into the insertion portion, and the drive axis is pressed against the driven portion by the leaf spring, while the leaf spring is engaged with the engagement holding portion and held by the moving body.
(16) In an imaging apparatus having a lens barrel inside of which an optical element is disposed and a drive device driving the optical element, the drive device includes a moving body that has a driven portion in which an engagement holding portion is provided and an insertion portion is formed being open at least on one side thereof and an element holding portion which holds an optical element; a piezoelectric driver that has a piezoelectric element and a drive axis, in which the piezoelectric element expands and contracts when a voltage is applied thereto, the drive axis is displaced in an expansion-contraction direction of the piezoelectric element in response to the expansion-contraction of the piezoelectric element and moves the moving body, and the drive axis is inserted into the insertion portion; a leaf spring that is inserted into the insertion portion, is held by the moving body and urges the drive axis to the driven portion in a pressing direction; and in a state in which the leaf spring is inserted into the insertion portion, the leaf spring is elastically deformed in the insertion portion by inserting the drive axis which is inserted into the insertion portion, and the drive axis is pressed against the driven portion by the leaf spring, while the leaf spring is engaged with the engagement holding portion and held by the moving body.

It should be understood by those skilled in the art that various modifications, combinations, sub-combinations and alterations may occur depending on design requirements and other factors insofar as they are within the scope of the appended claims or the equivalents thereof.

What is claimed is:

1. A drive device comprising:
a moving body that has a driven portion in which an engagement holding portion is provided and an insertion portion is formed being open at least on one side thereof and an element holding portion which holds an optical element;
a piezoelectric driver that has a piezoelectric element and a drive axis, in which the piezoelectric element expands and contracts when a voltage is applied thereto, the drive axis is displaced in an expansion-contraction direction of the piezoelectric element in response to the expansion-contraction of the piezoelectric element and moves the moving body, and the drive axis is inserted into the insertion portion; and
a leaf spring that is inserted into the insertion portion, is held by the moving body and urges the drive axis to the driven portion in a pressing direction,
wherein in a state in which the leaf spring is inserted into the insertion portion, the leaf spring is elastically deformed in the insertion portion by inserting the drive axis which is inserted into the insertion portion, and the drive axis is pressed against the driven portion by the leaf spring, while the leaf spring is engaged with the engagement holding portion and held by the moving body.

2. The drive device according to claim 1,
wherein a press-down portion is provided in the driven portion, and
in a state in which the leaf spring is held by the moving body, dislodgement of the leaf spring with respect to the insertion portion is regulated by the press-down portion.

3. The drive device according to claim 1,
wherein the leaf spring is formed in a manner where an insertion-extraction direction thereof with respect to the insertion portion is set as a short direction, and
the engagement holding portions are provided being spaced apart from each other in a longitudinal direction of the leaf spring.

4. The drive device according to claim 3,
wherein two of the engagement holding portions respectively engage with both end portions of the leaf spring in the longitudinal direction.

5. The drive device according to claim 3,
wherein two of the engagement holding portions engage with the leaf spring by being in line contact therewith.

6. The drive device according to claim 1,
wherein the drive axis is in line contact with the moving body at two points.

7. The drive device according to claim 1,
wherein a metal plate abutting on the drive axis is attached to an inner wall surface of the insertion portion.

8. The drive device according to claim 1,
wherein a pressing protrusion portion being in line contact or point contact with the drive axis is provided on the leaf spring.

9. The drive device according to claim 2,
wherein the press-down portion is formed in a protruding manner so as to cover a portion of an opening of the insertion portion.

10. The drive device according to claim 2,
wherein the leaf spring is formed in a manner where an insertion-extraction direction thereof with respect to the insertion portion is set as a short direction,
the press-down portion is positioned in the insertion portion, and
pressed-down portions respectively pressed by the press-down portions are provided on at least one end portion of the leaf spring in the short direction and both end portions thereof in a longitudinal direction.

11. The drive device according to claim 2,
wherein the leaf spring is formed in a manner where an insertion-extraction direction thereof with respect to the insertion portion is set as a short direction, and
pressed-down portions respectively pressed by the press-down portions are provided on a central portion of the leaf spring in the short direction and both end portions thereof in a longitudinal direction.

12. The drive device according to claim 1,
wherein the leaf spring is formed in a manner where an insertion-extraction direction thereof with respect to the insertion portion is set as a short direction, and
at least one end portion of the leaf spring in a longitudinal direction is bent to serve as a bent portion.

13. The drive device according to claim 1,
wherein a case body is provided having an axis insertion hole into which the drive axis is inserted and an attachment portion to which the piezoelectric element is attached.

14. The drive device according to claim 1,
wherein a tapered surface extending in a circumferential direction is provided at an end portion of the drive axis on a side inserted into the insertion portion.

15. A lens barrel inside of which a drive device driving an optical element is disposed,
wherein the drive device includes a moving body that has a driven portion in which an engagement holding portion is provided and an insertion portion is formed being open at least on one side thereof and an element holding portion which holds an optical element;
a piezoelectric driver that has a piezoelectric element and a drive axis, in which the piezoelectric element expands and contracts when a voltage is applied thereto, the drive axis is displaced in an expansion-contraction direction of the piezoelectric element in response to the expansion-contraction of the piezoelectric element and moves the moving body, and the drive axis is inserted into the insertion portion;
a leaf spring that is inserted into the insertion portion, is held by the moving body and urges the drive axis to the driven portion in a pressing direction; and
in a state in which the leaf spring is inserted into the insertion portion, the leaf spring is elastically deformed in the insertion portion by inserting the drive axis which is inserted into the insertion portion, and the drive axis is pressed against the driven portion by the leaf spring, while the leaf spring is engaged with the engagement holding portion and held by the moving body.

16. An imaging apparatus having a lens barrel inside of which an optical element is disposed and a drive device driving the optical element,
wherein the drive device includes a moving body that has a driven portion in which an engagement holding portion is provided and an insertion portion is formed being open at least on one side thereof and an element holding portion which holds an optical element;
a piezoelectric driver that has a piezoelectric element and a drive axis, in which the piezoelectric element expands and contracts when a voltage is applied thereto, the drive axis is displaced in an expansion-contraction direction of the piezoelectric element in response to the expansion-contraction of the piezoelectric element and moves the moving body, and the drive axis is inserted into the insertion portion;
a leaf spring that is inserted into the insertion portion, is held by the moving body and urges the drive axis to the driven portion in a pressing direction; and
in a state in which the leaf spring is inserted into the insertion portion, the leaf spring is elastically deformed in the insertion portion by inserting the drive axis which is inserted into the insertion portion, and the drive axis is pressed against the driven portion by the leaf spring, while the leaf spring is engaged with the engagement holding portion and held by the moving body.
